(19) United States
(12) Patent Application Publication
(10) Pub. No.: US 2020/0254361 A1
(43) Pub. Date: Aug. 13, 2020

(54) HOST-GUEST EXTRACTION METHOD OF HEAVY METALS

(71) Applicant: King Fahd University of Petroleum and Minerals, Dhahran (SA)

(72) Inventors: Md. Hasan ZAHIR, Dhahran (SA); Shakhawat CHOWDHURY, Dhahran (SA); Khalid ALHOOSHANI, Dhahran (SA)

(73) Assignee: King Fahd University of Petroleum and Minerals, Dhahran (SA)

(21) Appl. No.: 16/273,206

(22) Filed: Feb. 12, 2019

(51) Int. Cl. B01D 11/04; C02F 1/26

(52) U.S. Cl. CPC B01D 11/0492; C02F 2101/20; C02F 1/26

(57) ABSTRACT

A liquid-liquid extraction method for the removal of metal ions from contaminated water using calix[n]arene compound and a nitrogen base is disclosed. The method is particularly useful for removal of transition metal ions from contaminated water.

### STATEMENT REGARDING PRIOR DISCLOSURE BY THE INVENTORS

Aspects of this technology are described in an article “Host-guest extraction of heavy metal ions with p-t-butylcalix[8]arene from ammonia or amine solutions” International Journal of Analytical Chemistry, Volume 2018, Article ID 4015878, 11 pages. The article was published online Jun. 21, 2018.

### BACKGROUND OF THE INVENTION

### Field of the Disclosure

This disclosure relates to a method of removing one or more heavy metals, such as a transition metal, from an aqueous composition using a calixarene compound in an organic solvent by liquid-liquid extraction.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

Host-guest chemistry has attracted considerable attention in the field of separation and/or extraction of alkaline, rare earth, and divalent heavy metal ions with calixarenes and related ester derivatives. Calixarenes are able to identify and distinguish between different ions or molecules [Vicens et al. Calixarenes: A versatile Class of Macrocyclic Compounds, Kluwer Academic publishers, Dordrecht (1991); Gutsche, C. D. “Calixarenes” The Royal Society of Chemistry, Cambridge, pp. 181 (1989); and Ohto, et al. “Effect of coexisting alkaline metal ions on the extraction selectivity of lanthanide ions with calixarene carylate derivatives” Polyhedron, Vol. 16 (10), pp. 1656-1661 (1997)]. Calixarenes are macrocyclic phenolic oligomers with phenolic hydroxyl groups, which are able to coordinate metal ions. The aromatic phenolic rings form a cavity to accommodate a guest metal ion. Recently, Yusof et al. reported that heavy metal ions bind to a host calix[4]resorcinarene cavity in water-chloroform extraction systems [Yusof et al. “Predominant hosting lead(II) in ternary mixtures of heavy metal ions by a novel of diethylaminomethyl-calix[4]resorcinarene” Int. J. Environ. Sci. Technol, pp. 1063-1072 (2014); and Yusof et al. “Ionic imprinted calix[4]resorcinarene host for Pb(II) adsorbent using diallylaminomethyl-calix[4]resorcinarene copolymer” Chem. Lett., Vol. 42(10), pp. 1119-1121 (2013)]. Also, carboxylic acid substituted calix[6]arenes bind and extract immunoglobulin G (IgG) [Martinez-Aragón et al. “Host-guest extraction of immunoglobulin G using calix[6]arenas” Sep. and Puri. Tech., Vol. 65, pp. 73-78 (2009)]. In fact, a specific affinity may be engineered for target ions and/or molecules by modification the hydroxyl functional group of the calixarene and/or by increasing or decreasing the calixarene cavity size [Oshima et al. “Complex formation of cytochrome c with a calixarene carboxylic acid derivative: a novel solubilization method for biomolecules in organic media” Biomacromolecules, Vol. 3, pp. 438-444 (2002)]. In calixarenes, the cavity size, position, and type of donor groups as well as molecular flexibility lead to high potential for the complexation and extraction of metal ions. R. Ludwig [“Calixarenes in analytical and separation chemistry” Fresenius J Anal Chem, Vol. 367, pp. 103-128 (2000)] reported the impact of calixarenes in analytical chemistry and chemical separation technology in a review article.

Modifications of p-t-butylcalix[n]arenes, where n=4, 6, and 8, have been extensively investigated. Syntheses of variety of compounds with varying shapes and sizes have been described and shown to be valuable tool to study ion and/or molecular recognition [Gutsche et al. “Calixarenes. 4. The synthesis, characterization, and properties of the calixarenes from p-tert-butylphenol” J Am. Chem. Soc., Vol. 103, pp. 3782-3792 (1981), and Gutsche, and Nam “Calixarenes. 22. Synthesis, properties, and metal complexation of aminocalixarenes” J. Am. Chem. Soc., Vol. 110, (18), pp. 6162-6272 (1988)]. In particular, p-t-butylcalix[8]arene (H8L) has shown interesting complexing properties towards C60-fullerene, cesium, and strontium cations leading to new synthetic routes of new functionalized derivatives of H8L [Chen et al. “Unravelling the structure of the C60 and p-butyl-calix[8]arene complex” Chem. Commun., Vol. 51, pp. 11413-11416, 2015].

H8L forms host-guest complexes through hydrophobic and π-π-electron interactions within the cavity formed by benzene rings. Polycyclic aromatic hydrocarbons, anthraquinones, phenol regioisomers, and fullerenes are hosted by H8L and form complexes through their it-systems [Atwood et al. “Controlling van der Waals contacts in complexes of fullerene C60” Angew. Chem. Int. Ed. Vol. 42, pp. 3254-3257 (2003)]. Although coordination of metal ions to H8L is less examined and more complicated than that of calix[6]arene (H6L); several examples of calix[8]crown derivatives ligated to metal ions have been reported [Geraci et al. “Cation encapsulation within a ten-oxygen spheroidal cavity of conformationally pre-organized 1,5-3,7-calix[8] bis-crown-3derivatives” Chem. Commun., pp. 921-922 (1997); and Redshaw, C. “Coordination chemistry of the larger calixarenes” Coord. Chem. Reviews, Vol. 244, pp. 45-70 (2003)]. Metal ion coordination to calix[n]arenes can be enhanced by substituents having non-bonding electrons such as amino and/or hydroxyl groups into the upper and lower rim positions of the calixarene moiety to ligate metal ions [Kajiwara et al. “Transition metal and lanthanide cluster complexes constructed with thiacalix[n]arene and its derivatives” Coord Chem Rev., Vol. 251, pp. 1734-1746, 2007]. It has been reported that a proton transfer from a hydroxyl group of the parent calixarene to an amine substituents may aid the coordination to metal ions and formation of a complex [Ludwig et al. “Calixarene-based molecules for cation recognition” Sensor, Vol. 2, pp. 397-416 (2002)]. Finally, the above mentioned studies have established that calixarenes react effectively with most metal ions, and the organometallic complex can be obtained in good yields [Liu et al. “Chromogenic calixarene sensors for amine detection” Sensors and Actuators B., Vol. 108, pp. 521-527 (2005), R. Ludwig (2000), and Gutsche et al. (1981) and (1988)].

H8L has been utilized in the separation of metallic cations [Izatt et al. D “Selective M⁺-H⁺ coupled transport of cations through a liquid membrane by macrocyclic calixarene ligands” J. Am. Chem. Soc., Vol. 105 (7), pp. 1782-1785 (1983); and Izatt et al. “Cation transport from multiple alkali cation mixtures using a liquid membrane system containing a series of calixarene carriers” J. Am. Chem. Soc., Vol. 107, pp. 63-66 (1985)], the extraction of methyl esters of some amino-acids [Mutihac et al. “Liquid-liquid extraction and transport through membrane of amino acid methylesters by calix[n]arene derivatives” J. Incl. Phenom. Macrocycl. Chem., Vol. 59, pp. 177-181 (2007)], pre-concentration of uranium (VI) [Ayata et al. “p-tert-butylcalix [8]arene loaded silica gel for preconcentration of uranium (VI) via solid phase extraction” J. Radioanal. Nucl. Chem., Vol. 283 (3), pp. 603-607 (2010)], lanthanide complexes [Puntus et al. “Lanthanide complexes with a calix[8]arene bearing phosphinoyl pendant arms” Eur. J. Inorg. Chem., pp. 2315-2326 (2007)], and for molecular recognition of 1,5-diaminoanthraquinone [Suganthi et al. “Molecular recognition of 1,5-diaminoanthraquinone by p-tert-butyl-calix[8]arene,” J. Fluoresc., Vol. 20, pp. 1017-1022 (2010).]. Erdemir et al. investigated the extraction abilities of carboxylic acid and methyl ester derivatives ofp-t-butylcalix[n]arenes (n=6, 8) for carcinogenic aromatic amines [Erdemir et al. “Extraction of carcinogenic aromatic amines from aqueous solution using calix[n]arene derivatives as carrier,” J. Hazard. Mater. Vol. 168, 1170-1176 (2009)]. Other calixarenes and their derivatives have been utilized in complexation, separation, electroanalysis, spectroscopy, and chemometrics [Yoshida et al. “Solvent extraction of copper (II) ion with p-t-butylcalix[6]arene from the ammonia alkaline solutions,” Chem. Lett. pp 1535-1538 (1989)].

A larger ligand such as H8L, can act as a ditopic receptor for lanthanide and transition metal ions [Tasheva et al. “Synthesis of octa(1,1,3,3-tetramethylbutyl)octakis (dimethylphosphinoyl-methyleneoxy)calix[8]arene and its application in the synergistic solvent extraction and separation of lanthanoids” Sep. Puri. Tech., Vol. 64, pp. 170-175 (2008)] and hence in principle may bind to a single metal ion in various ways. It is important to mention that solvent extraction of transition metal ions, particularly toxic metal ions, using H8L alone has scarcely been reported. Makrlik et al. [“Solvent extraction of europium trifluoromethanesulfonate into nitrobenzene in the presence of p-tert-butylcalix[6]arene and p-tert-butylcalix[8]arene” J. Radioanal. Nucl. Chem., Vol. 287, pp. 277-280 (2010)] studied the liquid-liquid extraction of Eu³⁺ trifluoromethanesulfonate into nitrobenzene in the presence of H6L and H8L. Sansone et al. [CMPO-substituted calix[6]- and calix[8]arene extractants for the separation of An³⁺/Ln³⁺ from radioactive waste,” Tetrahedron, Vol. 62, pp. 6749-6753, 2006]reported the separation of An³⁺/Ln³⁺ from radioactive waste using carbamoylmethyl-phosphine oxide substituted H6L and H8L. Gutsche et al. [“Calixarenes. 22. synthesis, properties, and metal complexation of aminocalixarenes” J. Am. Chem. Soc. Vol. 110, pp. 6153-6162 (1988b)]reported the synthesis of aminocalixarene complexes of Ni²⁺, Cu²⁺, Pd²⁺, Co²⁺, and Fe²⁺ and determined their spectral and chemical characteristics. Their results indicated that metal-aminocalixarenes are more flexible than has previously been thought. Also, it has been reported that H8L can be combined into a polymeric medium to produce a material that shows a high sorption ability towards transition metal ions (Cu²⁺, Fe²⁺, Zn^{2+,} Ni²⁺, Co²⁺, Cd²⁺, and Pb²⁺) in aqueous solution [Pathak et al. “Synthesis and metalsorption studies of p-tert-butylcalix[8]arene chemically bound to polymeric support” Anal. Chimi. Acta., Vol. 335, pp. 283-290 (1996)]. In addition, the extraction behavior of transition metal ions with calix[4]arene (H4L) and H6L [Zahir, Md. H. “Synthesis and characterization of trivalent cerium complexes of p-tert-butylcalix [4, 6, 8] arenes: Effect of organic solvents” J. Chem. Volume 2013, ID 494392, 9 (2013); and Masuda and Zahir, “The host-guest extraction chemistry of lighter lanthaniod (III) metal ions with p-t-butylcalix[6]arene from the ammonia alkaline solution in presence of succinic acid,” Anal. Sci., Vol. 17, pp. a483-a486 (2001)].

An effective extraction with high selectivity for metal ions is in high demand for analytical applications, recycling of resources, and waste treatment purposes. Heavy metals such as lead (Pb), copper (Cu), nickel (Ni), are harmful to humans. Obviously, the harmful impact of some ions, for example Cd²⁺ and As²⁺ is of great concern. Cd²⁺ is one of the most toxic elements for humans. At high concentrations, it causes various debilitating conditions such as painful bone disease, bone marrow disorders, kidney problems, and “Itaiitai” or “ouch-ouch” disease [De, A. K. Environmental Chemistry, New age international Ltd., Inorganic Chemistry and Analysis through Problems and Exercises, pp. 80-81 (2005)]. However, calixarene derivatives may be useful binders for these cations.

Accordingly, it is an object of the present disclosure to provide a method for the removal of toxic metal ions from contaminated water using a calixarene compound in organic solvent containing ammonia or amine.

### SUMMARY OF THE INVENTION

A first aspect of the invention is directed to a liquid-liquid extraction method of metal ions from that includes dissolving a calix[n]arene compound in an organic solvent immiscible with water to form an organic solution,

mixing the organic solution with aqueous composition containing metal ions to form a complex between the calixarene and the metal to extract the metal from the aqueous composition.

In a preferred embodiment the method, the calix[n]arene compound is substituted with an optionally substituted C1 to C10 linear or branched alkyl, an optionally substituted C3 to C8 cycloalkyl, an optionally substituted aryl, an optionally substituted heteroaryl substituted, OR1, SR1, SeR1 and NR1R2, wherein R1 and R2 are independently hydrogen, an optionally substituted C1 to C10 linear or branched alkyl, an optionally substituted aryl, or an optionally substituted heteroaryl.

In another preferred embodiment of the method, the calix[n]arene compound is substituted with an optionally substituted methyl, an optionally substituted ethyl, an optionally substituted propyl, an optionally substituted n-butyl, an optionally substituted isobutyl, an optionally substituted t-butyl, an optionally substituted pentyl, an optionally substituted iso-pentyl, and an optionally substituted hexyl.

In a more preferred embodiment of the method, the calix[n]arene compound is a calix[8]arene compound.

In a more preferred embodiment of the method, the calix[8]arene compound is p-t-butylcalix[8]arene.

In another preferred embodiment of the method, the organic solvent is selected from the group consisting of nitrobenzene, chloroform, dichloromethane, and dichloroethane.

In another preferred embodiment of the method, the concentration of the calix[n]arene compound is in the range of 10 μM to 1.0 mM.

In another preferred embodiment of the method, the water comprises a nitrogen base at concentration in the range of 0.05 to 0.2 M.

In another preferred embodiment of the method, the nitrogen base is selected from the group consisting of ammonia, ethylene diamine, and trimethylene diamine.

In another preferred embodiment of the method, the mixture further comprises dicarboxylic acid.

In a more preferred embodiment of the method, the dicarboxylic acid is succinic acid.

In a more preferred embodiment of the method, the pH of the water is in the range of 11.0 to 13.5.

In another preferred embodiment of the method, the metal ion is a transition metal ion.

In another preferred embodiment of the method, the transition metal ion is selected from the group consisting of Cd⁺², Ni⁺², Cu⁺², Ag⁺, Co⁺², and Zn⁺².

In another preferred embodiment of the method, the extracted metal ion-calix[n]arene complex is treated with an aqueous acid solution selected from the group consisting of hydrochloric acid, nitric acid, and sulfuric acid to regenerate the free calix[n]arene.

A second aspect of the invention is directed to a liquid-liquid extractor comprising a solution of calix[n]arene compound in an organic solvent immiscible with water, wherein n is an integer selected from the group consisting of 5, 7, 8, 9, and 10.

In a preferred embodiment, the liquid-liquid extractor is a continuous counter current extractor.

In another preferred embodiment, the liquid-liquid extractor is a mixer-settler extractor.

In another preferred embodiment the liquid-liquid extractor, the calix[n]arene compound is substituted with an optionally substituted C1 to C10 linear or branched alkyl, an optionally substituted C3 to C8 cycloalkyl, an optionally substituted aryl, an optionally substituted heteroaryl substituted, OR₁, SR₁, SeR₁ and NR₁R₂, wherein R₁ and R₂ are independently hydrogen, an optionally substituted C1 to C10 linear or branched alkyl, an optionally substituted aryl, or an optionally substituted heteroaryl.

In another preferred embodiment the liquid-liquid extractor, the calix[n]arene compound is substituted with an optionally substituted methyl, an optionally substituted ethyl, an optionally substituted propyl, an optionally substituted n-butyl, an optionally substituted isobutyl, an optionally substituted t-butyl, an optionally substituted pentyl, an optionally substituted iso-pentyl, and an optionally substituted hexyl.

In another preferred embodiment the liquid-liquid extractor, the calix[n]arene compound is a calix[8]arene compound.

In another preferred embodiment the liquid-liquid extractor, the calix[8]arene compound is p-t-butylcalix[8]arene.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows the chemical structure of t-butylcalix[8]arene.

FIG. 2 shows pH profile for the extraction of metal ions into organic phase containing 0.5 mM H8L from an aqueous phase containing 10 mM succinic acid, 100 mM buffer, 0.1 mM metal ion, and a ratio of organic phase (O)/aqueous phase (A) of 1.0.

FIG. 3 shows the effect of an organic solvent containing 0.5 mM H8L on the extraction of Ni⁺² from aqueous solution containing 50 μM Ni⁺², 10 mM succinic acid, 100 mM buffer, and O/A of 1.0 at different pH's at 25° C.

FIG. 4 shows the effect of an organic solvent containing 0.5 mM H8L on the extraction of Cd⁺² from aqueous solution containing 50 μM Ni⁺², 10 mM succinic acid, 100 mM buffer, and O/A of 1.0 at different pH's at 25° C.

FIG. 5 shows a plot of log D vs log [H8L] for Cd⁺² and Ni⁺² measured under the same condition stated for FIG. 4.

FIG. 6 shows a plot of log D vs log [NH₃] for Cd⁺² and Ni⁺² measured under the same condition stated for FIG. 4.

FIG. 7 shows a plot of percentage of metal ion extraction vs [H8L]/[M⁺²] under the condition described for FIG. 4. Inverted triangle and circles represent different extraction experiments under the same conditions for Cd⁺² and diamond and circles represent different extraction experiments under the same conditions for Ni⁺.

FIG. 8A show FESM image of H8L.

FIG. 8B show FESM image of Cd⁺²-H8L complex.

FIG. 8C show FESM image of Cd⁺²-H8L complex at higher magnification.

FIG. 9A shows EDX spectra of H8L.

FIG. 9B shows EDX spectra of Cd⁺²-H8L complex for regions marked by arrows in FIGS. 8B and 8C.

FIG. 10 shows FTIR spectra of H8L [top spectra (a)] and Cd⁺²-H8L complex [bottom spectra (b)].

FIG. 11A shows NMR spectra of H8L in CDCl₃ at 25° C. and 400 MHz.

FIG. 11B shows NMR spectra of Cd⁺²-H8L complex in CDCl₃ at 25° C. and 400 MHz.

FIG. 12 shows percentage of metal ion extracted (Ex %) at pH 11.5 by H8L-ester with O/A of 1 at 25° C.

FIG. 13 shows the structure of Cu(en)₂-H8L complex.

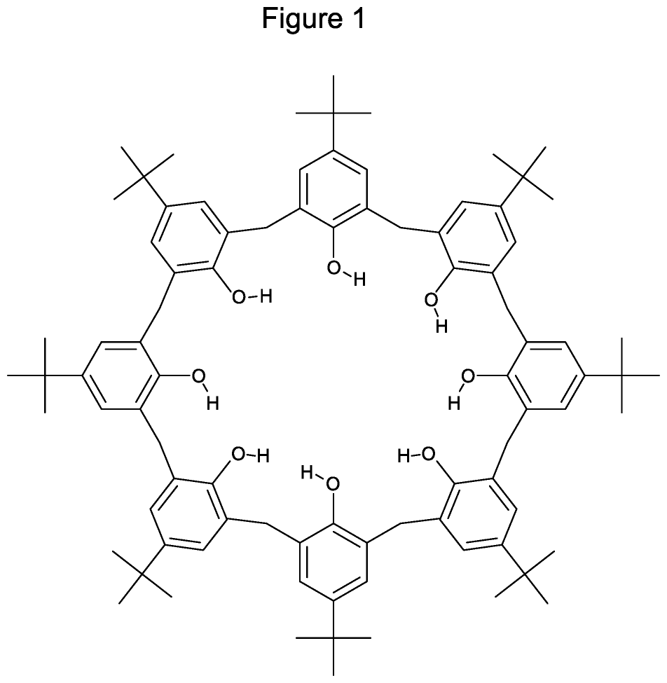

### DETAILED DESCRIPTION

Embodiments of the present disclosure will now be described more fully hereinafter with reference to the accompanying drawings, in which some, but not all embodiments of the disclosure are shown. The present disclosure will be better understood with reference to the following definitions.

All publications mentioned herein are incorporated herein by reference in full for the purpose of describing and disclosing the methodologies, which are described in the publications, which might be used in connection with the description herein. The publications discussed above and throughout the text are provided solely for their disclosure prior to the filing date of the present application. Nothing herein is to be construed as an admission that the inventors are not entitled to antedate such disclosure by virtue of prior disclosure. Also, the use of “or” means “and/or” unless stated otherwise. Similarly, “comprise,” “comprises,” “comprising” “include,” “includes,” and “including” are interchangeable and not intended to be limiting.

The terminology used herein is for the purpose of describing particular embodiments only and is not intended to be limiting of the invention.

The headings such as “Background” and “Summary”, and sub-headings used herein are intended only for general organization of topics within the present invention, and are not intended to limit the disclosure of the present invention or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

As used herein, the singular forms “a”, “an” and “the” are intended to include the plural forms as well, unless the context clearly indicates otherwise.

As used herein, the term “and/or” includes any and all combinations of one or more of the associated listed items and may be abbreviated as “/”.

As used herein, the term “compound” is intended to refer to a chemical entity, whether in a solid, liquid or gaseous phase, and whether in a crude mixture or purified and isolated.

The terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “substituted” refers to at least one hydrogen atom that is replaced with a non-hydrogen group, provided that normal valences are maintained and that the substitution results in a stable compound. When a substituent is noted as “optionally substituted”, the substituents are selected from the exemplary group including, but not limited to, halo, hydroxyl, alkoxy, oxo, alkanoyl, aryloxy, alkanoyloxy, amino, alkylamino, arylamino, arylalkylamino, disubstituted amines (e.g. in which the two amino substituents are selected from the exemplary group including, but not limited to, alkyl, aryl or arylalkyl), alkanylamino, aroylamino, aralkanoylamino, substituted alkanoylamino, substituted arylamino, substituted aralkanoylamino, thiol, alkylation, arylthio, arylalkylthio, alkylthiono, arylthiono, aryalkylthiono, alkylsulfonyl, arylsulfonyl, arylalkylsulfonyl, sulfonamide (e.g. —SO₂NH₂), substituted sulfonamide, nitro, cyano, carboxy, carbamyl (e.g. —CONH₂), substituted carbamyl (e.g. —CONHalkyl, —CONHaryl, —CONHarylalkyl or cases where there are two substituents on one nitrogen from alkyl, aryl, or alkylalkyl), alkoxycarbonyl, aryl, substituted aryl, guanidine, heterocyclyl (e.g. indolyl, imidazoyl, furyl, thienyl, thiazolyl, pyrrolidyl, pyridyl, pyrimidiyl, pyrrolidinyl, piperidinyl, morpholinyl, piperazinyl, homopiperazinyl and the like), substituted heterocyclyl and mixtures thereof and the like.

As used herein, the term “alkyl” unless otherwise specified refers to both branched and straight chain saturated aliphatic primary, secondary, and/or tertiary hydrocarbons of typically C₁ to C₁₀, and specifically includes, but is not limited to, methyl, trifluoromethyl, ethyl, propyl, isopropyl, cyclopropyl, butyl, isobutyl, t-butyl, pentyl, cyclopentyl, isopentyl, neopentyl, hexyl, isohexyl, cyclohexyl, cyclohexylmethyl, 3-methylpentyl, 2,2-dimethylbutyl, and 2,3-dimethylbutyl. As used herein, the term optionally includes substituted alkyl groups. Exemplary moieties with which the alkyl group can be substituted may be selected from the group including, but not limited to, hydroxyl, alkoxy, aryloxy, or combination thereof. The substituted moiety may be either protected or unprotected as necessary, and as known to those skilled in the art.

As used herein, the term “aryl” unless otherwise specified refers to functional groups or substituents derived from an aromatic ring including, but not limited to, phenyl, biphenyl, naphthyl, thienyl, and indolyl. As used herein, the term optionally includes both substituted and unsubstituted moieties. Exemplary moieties with which the aryl group can be substituted may be selected from the group including, but not limited to, hydroxyl, amino, alkylamino, arylamino, alkoxy, aryloxy, nitro, cyano, sulfonic acid, sulfate, phosphonic acid, phosphate or phosphonate or mixtures thereof. The substituted moiety may be either protected or unprotected as necessary, and as known to those skilled in the art.

As used herein, the term “salt” refers to derivatives of the disclosed compounds, monomers or polymers wherein the parent compound is modified by making acid or base salts thereof. Exemplary salts include, but are not limited to, mineral or organic acid salts of basic groups such as amines, and alkali or organic salts of acidic groups such as carboxylic acids. The salts of the present disclosure can be synthesized from the parent compound that contains a basic or acidic moiety by conventional chemical methods. Generally such salts can be prepared by reacting the free acid or base forms of these compounds with a stoichiometric amount of the appropriate base or acid in water or in an organic solvent, or in a mixture of the two; generally non-aqueous media like ether, ethyl acetate, ethanol, isopropanol, or acetonitrile are preferred.

As used herein, the term “about” refers to an approximate number within 20% of a stated value, preferably within 15% of a stated value, more preferably within 10% of a stated value, and most preferably within 5% of a stated value. For example, if a stated value is about 8.0, the value may vary in the range of 8±1.6, ±1.0, ±0.8, ±0.5, ±0.4, ±0.3, ±0.2, or ±0.1.

A first aspect of the invention is directed to a liquid-liquid extraction method of metal ions present in aqueous composition comprising:

dissolving a calix[n]arene compound in an organic solvent immiscible with water to form an organic solution wherein n is an integer selected from the group consisting of 5, 7, 8, 9, and 10,

mixing the organic solution with aqueous composition containing metal ions to form a mixture,

optionally agitating the mixture for a time in the range of 20 min to 30 hours, and

allowing the mixture to separate into an organic layer and an aqueous layer, and

separating the aqueous layer from the organic layer.

As used herein, the term “calixarene” refers to a family of macrocycle or cyclic oligomers obtained by hydroxyalkylation of a phenol and an aldehyde. Calixarenes are characterized by a three-dimensional basket, cup or bucket shape. The word calixarene is derived from calix or chalice because the molecule resembles a vase and from the word arene which refers to the aromatic building block. Calixarenes have hydrophobic cavities that can hold smaller molecules or ions and belong to the class of cavitands known in host-guest chemistry. Calixarene nomenclature is straight forward. It involves counting the number of repeating units in the ring, and including the number in the name. For example, a calix[4]arene has 4 repeating units in the ring, a calix[6]arene has 6 repeating units, and a calix[8]arene has 8 repeating units. A substituent in the meso position R_{b} is added to the name with a prefix C- as in C-methylcalix[6]arene; see https://_en.wikipedia.org/wiki/Calixarene (last accessed Sep. 6, 2017, incorporated herein by reference). Representative chemical structures include:

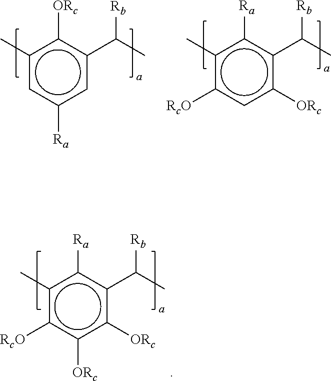

Where Rₐ, R_{b}, and R_{c} are independently hydrogen, alkyl group of C1 to C10, cycloalkyl of C3 to C10, and heteroalkyl, and n is 4, 5, 6, 7, 8, 9, and 10.

The cup or bucket shape structure of calixarenes is characterized by a wide upper rim, a narrow lower rim, and a central annulus. With phenol as a starting material, the hydroxyl groups are intra-annular on the lower rim. In a resorcin[4]arene, 8 hydroxyl groups are placed extra-annular on the upper ring. Calixarenes may exist in different chemical conformations because the rotation around the methylene bridge is somewhat restricted. The hydroxyl groups form a hydrogen bond network that stabilizes the cone conformation. In solution, several conformations of calixarene are in dynamic equilibrium. Conformations may be restricted with proper substituents that increase the rotation barrier. For example, a bulky substituent on the upper rim of calixarene, e.g., the para position of a phenol, would lock the molecule in one conformation such as in the case of cone shaped p-t-butylcalixarene.

Any calixarene may be utilized in the method of invention as long as the calixarene is able to form a metal ion-nitrogen base-calixarene complex. In a preferred embodiment, the calixarene used in the method has one of the structures shown above having an n value of 4, 5, or 6, preferably 7, 8, 9 or 10, more preferably 7, 8, or 9, and most preferably 8.

The calixarene used in the method of the invention may have one or more substituents. The substituent may be on the bridging carbon between two aromatic rings (R_{b} in the structures shown above), the 4-position, also known as the p-position, of the aromatic ring (Rₐ in the structures shown above), the phenolic oxygen (R_{c} in the structures shown above) or combination thereof. In a preferred embodiment of the invention, the calixarene used in the method has substituent on the 4-position of the aromatic ring. The substituent may be an optionally substituted C1 to C10 linear or branched alkyl, an optionally substituted C3 to C8 cycloalkyl, an optionally substituted aryl, an optionally substituted heteroaryl substituted, OR₁, SR₁, SeR₁ and NR₁R₂, wherein R₁ and R₂ are independently hydrogen, an optionally substituted C1 to C10 linear or branched alkyl, an optionally substituted aryl, or an optionally substituted heteroaryl

In a preferred embodiment of the method of the invention, the calixarene is substituted in the 4-position with an alkyl group such as but not limited to methyl, ethyl, n-propyl, isopropyl, n-butyl, isobutyl, t-butyl, n-pentyl and isomers thereof, cyclopentyl, n-hexyl and isomers thereof, n-heptyl or isomers thereof, cycloheptyl, and n-octyl and isomers thereof, and cyclooctyl. In a particularly preferred embodiment, the calixarene used in the method of the invention is t-butylcalixarene, in particular, p-tert-butylcalix[8]arene.

The concentration of calixarene in the organic solution may vary depending on the solubility of the calixarene the organic solvent and the amount of the metal ion being extracted. In some embodiments The concentration of calixarene in the organic solution is in the range of 1.0 μM to 10 mM, preferably in the range of 5.0 μM to 1.0 mM, more preferably in the range of 10 μM to 500 μM, most preferably in the range 20 μM to 200 μM. In a particularly preferred embodiment, the concentration of the calixarene is 50 μM.

Any organic solvent immiscible with water may be utilized in the method of the invention as long as the calixarene is sufficiently soluble in the solvent. Examples of organic solvents immiscible with water include but are not limited to pentane, cyclopentane, hexane, cyclohexane, petroleum ether, ethers such as dimethyl ether, methylethyl ether, diethylether and the like, halogenated hydrocarbons such as chloromethane, dichloromethane, chloroform, carbontetrachloride, 1,2-dichloroethane, and the like, benzene, toluene, o-xylene, m-xylene, p-xylene, nitrobenzene, aniline and the like. In a preferred embodiment, the organic solvent is dichloromethane, more preferably chloroform, and most preferably nitrobenzene

In some preferred embodiments, the water comprises a nitrogen base such as ammonia, primary or secondary aliphatic amines, cyclic amines, aromatic amines or heterocyclic amines. The primary aliphatic amines include, but are not limited to, methyl amine, ethyl amine, propyl amine, isopropyl amine, n-butyl amine, isobutyl amine, tert-butyl amine, n-pentyl amine and isomers thereof, hexyl amine and isomers thereof, ethylene diamine, trimethylene diamine and the like. Examples of secondary amines include, but not limited to, dimethyl amine, diethyl amines, dipropyl amine, dibutyl amine, dicyclopentyl amine, dicyclohexylamine, and the like. Examples of cyclic amines include, but not limited to pyrrolidine, piperidine, imidazolidine, and the like. Examples of aromatic amines includes but not limited to imidazole, pyridine, aniline, o-phenylenediamine, m-phenylenediamine, p-phenylenediamine, o-toluidine, m-toluidine, p-toluidine and the like. In a particularly preferred embodiment, the nitrogen base is selected from the group consisting of ammonia, diethylamine, and triethylene diamine. The concentration of the nitrogen base in the aqueous phase is in the range 0.01 M to 2.0 M, preferably in the range of 0.05 M to 1.5 M, more preferably in the range of 0.1 M to 1.2 M, and most preferably 0.5 M to 1.0 M.

The water phase has a pH in the range of 10.0 to 14.0, preferably in the range of 11.0 to 13.5, more preferably 11.5 to 13.00.

In other preferred embodiment, one or more dicarboxylic acid is added to minimize emulsion formation at a concentration in the range of 1.0 mM to 100 mM, preferably in the range 2.0 mM to 50 mM, more preferably 5.0 mM to 20 mM. and most preferably in the range of 8.0 mM to 12 mM. In a particularly preferred embodiment, the concentration of the dicarboxylic acid is 10 mM. Example of dicarboxylic acid includes oxalic acid, malonic acid, succinic acid, maleic acid, fumaric acid, and the like. In a preferred embodiment, succinic acid is used to minimize the formation of emulsion.

Any metal ion that forms a complex with calixarene in the presence of nitrogen amine may be removed from water by the method of the invention. In some embodiment the metal ion is a transition metal ion. As used herein, the term “transition metals” includes all the metals of the d-block of the periodic table. Examples of the transition metal include, but not limited to scandium, titanium, vanadium, chromium, manganese, iron, nickel, copper, zinc, zirconium, niobium, molybdenum, ruthenium, palladium, silver, cadmium, tungsten, osmium, and mercury. In a preferred embodiment, the metal ion is selected from the group consisting cadmium, nickel, copper, silver, cobalt, and zinc. In a more preferred embodiment, the metal ion is selected from the group consisting of Cd⁺², Ni⁺², Cu⁺², Ag⁺, Co⁺², and Zn⁺².

In preferred embodiments of the method, the metal ion-calix[n]arene compound complex is treated when in the organic solvent with an aqueous solution of mineral acid such as but not limited to hydrochloric acid, nitric acid, and sulfuric acid. Such a treatment leads to the regeneration of the free the calix[n]arene compound which enables it to be reuse in the method of the invention.

A second aspect of the invention is directed to a liquid-liquid extractor comprising a solution of calix[n]arene compound in an organic solvent immiscible with water, wherein n=5, 7, 8, or 9. Liquid-liquid extractor varies in size and shape. The most common laboratory liquid-liquid extractor is a separatory funnel wherein an aqueous phase and organic phase, one of which contains a solute, are shaken and allowed to separate into two phases. The bottom phase is removed from the bottom of the separatory funnel through a valve. Counter current extractors are used in a laboratory scale apparatus or industrial scale plants. In such an extractor, the organic and aqueous phases are flowing in opposite directions. Counter current extractors may be a single stage or multistage extractor. A continuous multistage counter current extractor comprises an array of counter current extractors. In such a reactor, the method of the invention is carried out by pumping the water contaminated with heavy metals through a series of counter current extractors containing one or more solutions of calixarene compound in a water-immiscible organic solvent. The organic solvent in the reactor may be any water-immiscible organic solvent in which the calixarene compound is sufficiently soluble. Another type of counter current extractor is known as mixer-settler in which battery of counter current extractors are interconnected. Such a configuration allows for a mixing of the organic and aqueous phases, followed by a settling of the two phases to be separated before moving to another extractor.

In some embodiments of the invention, the extractor is a counter current extractor, preferably a continuous counter current extractor or mixer-setter extractor containing a solution of water immiscible organic solvent containing calixarene, preferably calixarene compound selected from the group consisting calix[5]arene compound, calix[7]arene compound, calix[8]arene compound, calix[9]arene compound, and calix[10]arene compound. The calixarene compound of the invention is an optionally substituted C1 to C10 linear or branched alkyl, an optionally substituted C3 to C8 cycloalkyl, an optionally substituted aryl, an optionally substituted heteroaryl substituted, OR₁, SR₁, SeR₁ and NR₁R₂, wherein R₁ and R₂ are independently hydrogen, an optionally substituted C1 to C10 linear or branched alkyl, an optionally substituted aryl, or an optionally substituted heteroaryl

In some embodiments, the substituent is at one or more of the 3, 4, and/or 5-positions of the aromatic rings wherein the substituent is C1 to C10 alkyl group. In a preferred embodiment of the invention, the substituent is t-butyl group at the 4-position of the aromatic ring.

In preferred embodiments the extractor of the invention comprises a regeneration unit in which the organic phase comprising the metal ion complex is treated in countercurrent extractor with an acid selected from the group consisting of hydrochloric acid, nitric acid, sulfuric acid, and the like. After the treatment, the organic solution comprising the free calix[n]arene compound is recirculated in the extractor.

### Example 1

### Materials:

H8L was purchased from the Sigma-Aldrich Chemical Company, USA. All transition metal nitrate solutions were prepared from analytical grade nitrate salts as previously described [Zahir, Md. H. “Synthesis and characterization of trivalent cerium complexes ofp-tert-butylcalix [4, 6, 8] arenes: Effect of organic solvents” J. Chem. Volume 2013, ID 494392, 9 (2013); and Masuda and Zahir, “The host-guest extraction chemistry of lighter lanthaniod (III) metal ions with p-t-butylcalix[6]arene from the ammonia alkaline solution in presence of succinic acid,” Anal. Sci., Vol. 17, pp. a483-a486 (2001) each incorporated herein by reference in its entirety]. Other reagents such as chloroform, dichloromethane and nitrobenzene and ethanol were purchased from Carlo Erba Reagents, France. Ammonia, ethylenediamine, trimethylene diamine, ethyl bromoacetate, sodium hydride, tetrahydrofuran, and dimethylformamide were purchased from Acros Organic, Belgium. Deionized water was used. All other reagents were commercially available and used without further purification. Stock solutions were standardized by potentiometric and EDTA titrations. Other metal salts were reagent grade.

### Method:

Extraction Procedure:

The host H8L and H8L ester were prepared by dissolving the appropriate amount of H8L and H8L ester in various organic solvents followed by dilution, typically to 100 μM. Aqueous metal solutions were made from analytical purity nitrates of Cd²⁺, Ni²⁺, Cu²⁺, Ag⁺, Co²⁺ and Zn²⁺. Extraction experiments were typically performed by equilibrating 8 mL of a 50 μM, 1 ml of buffer solution of the metal ions, 1 ml of 10 mM succinic acid, and 1 mL of a buffer solution with 10 mL of 500 μM solution of the H8L in 1,2-dichloroethane. The mixture was placed in a stoppered 50 mL glass tube at a volume ratio of 1:1 (organic phase to aqueous phase). The pH was adjusted by three types of buffer solution: CH₃COOH/CH₃COONa (acidic region), H₃BO₃/NaOH (neutral), and NH₃—NH₄Cl (alkali). In the case of H₈L-ester extractant, picric acid [2.5×10⁻⁵ M] was used as the counter anion. In case of H8L-ester extractant, picric acid [25 μM] was used as the counter anion. The extraction equilibrium was attained within 40 min of shaking with nitrobenzene; the extraction into chloroform reached equilibrium within 20 h of shaking. Therefore, the shaking time was fixed at 2 h for nitrobenzene and at 20 h for chloroform. The extractability was not affected by further shaking, indicating that the equilibrium was attained within 12 h. All the experiments were performed in the presence of succinic acid to avoid emulsification during the extraction process. The distribution experiments were performed at ambient temperature.

Before shaking, the samples were left standing in a water bath at 25° C. for 15 min to ensure that the extraction solutions were maintained at the same temperature. Then, the solutions were mixed by a shaker at 200 stroke min⁻¹ at 25.0±0.1° C. for 12 h, which was sufficient to reach the extraction equilibrium. After shaking, the two phases were centrifuged at 2000 rpm for 10 min to separate the two phases. Before the measurement, the pH of the aqueous was adjusted to 2.5 using 5 M HNO₃ and 3 M LiOH. The amount of extracted metal ions was calculated from the difference between the metal concentrations in the aqueous phase before and after the equilibration. The concentration of the metal ion in the organic phase was determined by the back-extraction method; 5 cm³ of the organic phase was transferred into another glass-stoppered tube and shaken with 4 M hydrochloric acid. After phase separation, the equilibrium concentrations of metal cations in the aqueous phase were measured by an inductively coupled plasma atomic emission spectrometer (Seiko model SPS 1200AR). The equilibrium pH in the aqueous solutions was measured by a pH meter (Beckmann model ø45).

The extractability (Ex %) was determined from the decrease in the metal concentration in the aqueous phase:

Ex%=[(Metal)_{blank}−(Metal)_{water}]/(Metal)]_{blank}}×100,

where [Metal]_{blank} and [Metal]_{water} denote the metal concentrations in the aqueous phase after extraction with nitrobenzene and with the nitrobenzene solution containing extractants, respectively, and [Metal]ₒᵣ denotes the metal concentration extracted into the organic phase.

Analysis:

Morphology of the product particles were examined using scanning electron microscopy (SEM, JEOL JSM6330F). Fourier transform infrared (FT-IR) spectra were obtained on a Bruker FT-IR spectrometer by using the KBr pellet technique. ¹H-NMR data were recorded on a JEOL JNM-GX 61D FT-NMR spectrometer operating at 400 MHz in CDCl₃, using TMS as internal standard.

### Example 2

### Preliminary Experiments:

Effect of H8L Concentration:

Experiments were performed using H8L concentrations in the range of 1 mM to 500 μM and a metal ion concentration of 50 μM; all other conditions were kept the same. The results showed that extraction percentage is increased with increasing H8L concentrations. The best extraction was achieved when 500 μM H8L was used. Since H8L was soluble in nitrobenzene up to 40 mM and up to 10 mM in 1,2-dichloroethane at ambient temperature, the saturated solution was used as stock solution.

Role of Extractant:

Nitrobenzene, dichloromethane, and chloroform were tested as inert solvents at a fixed pH for solutions containing an equal amount of metal ions and H8L. The phase volume ratio was maintained at 1:1 to avoid emulsion formation; which was found to be the most effective ratio. This means that the tendency for association is, in general, greater when the solvent-solute interactions are weaker; however, chloroform is the least effective. The exact cause of this type of behavior is not known. It was observed that the extraction percentage increased with the diluent type in the order of chloroform>dichloromethane>nitrobenzene.

Choice of Stripping Agent:

After extraction of Cd²⁺ with H8L, the metal ions were stripped with 7 mL of various concentrations of mineral acid reagents, specifically 4 M HCl, 0.1-5 M HNO₃, or 2 M H₂SO₄. Lower concentrations of nitric acid (<4.5 M) were not suitable as Cd²⁺ forms a stable complex. Finally, it was observed that 4 M HCl was suitable as a stripping agent.

Effect of Succinic Acid:

Small amounts of succinic were added to the reaction media to inhibit emulsification particularly in the case of Cd²⁺, Cu²⁺, and Cr³⁺ transition metal cations. By keeping all other parameters constant, experiments were performed using different concentrations of succinic acid. The best results were observed with 10 mM succinic acid which was included in all experiments. It is noteworthy to mention that upon addition the succinic acid into the highly basic buffer solution, the extraction percentage was stabilized perhaps due to the pH control.

### Example 3

Nature of the Extracted Species:

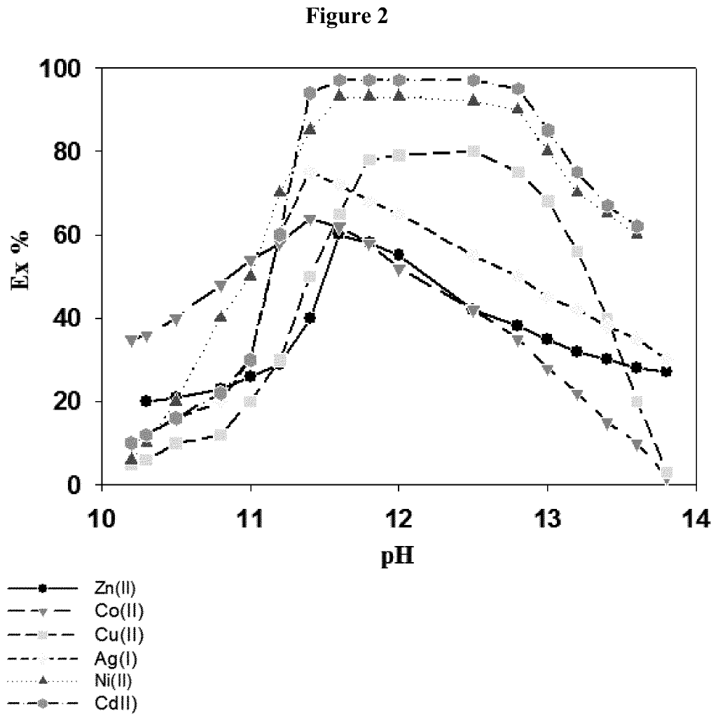

Initially, the effect of pH on the extraction of Cd^{2+,} Ni²⁺, Cu²⁺, Ag⁺, Co²⁺, Zn²⁺, Cr³⁺ and Mn²⁺ with H8L were examined. FIG. 2 shows that the percentage of metal ions extracted increases as the pH increases from 10.0 to 13.0. In the acidic or neutral pH region, metal ions were not extracted with H8L, whereas, at pH 11.3, more than 60% of metal ions were extracted with H8L. The maximum extraction percentage was observed in the pH range of the 11.5 to 13.00 for all tested samples. The extractability order is Cd²⁺>Ni²⁺>Cu²⁺>Ag⁺>Co²⁺>Zn²⁺. H8L has eight phenolic hydroxyl groups with pKa₁ about 10.0 indicating that at pH 11 at least one hydroxyl group is >99% deprotonated. A deprotonated hydroxyl group such as a phenoxide ion is more effective in extracting the metal ion to the organic phase. Among the cations tested, almost the same percentage of Cd²⁺ and Ni²⁺ ions were extracted under the experimental conditions. In contrast, no amounts of Cr³⁺ and Mn²⁺ were extracted, possibly due to the formation of a precipitate in ammonia solution.

The results indicate that H8L has a good affinity for selective complexation with transition metal ions. The study of pH effect indicates that the extraction mechanism depends on a proton exchange mechanism together with hydrogen-bonding. Petit et al. [“A dinuclear cobalt(II) complex of calix[8]arenes exibiting strong magnetic anisotropy” Dalton Trans., pp. 4582-4588 (2007)] reported a dinuclear cobalt(II) complex of calix[8]arenes compound, prepared by solvothermal reaction of cobalt(II) acetate with p-t-butylcalix[8]arene and trimethylamine; the compound was formed by hydrogen bond bridging Petit et al. [“A dinuclear cobalt(II) complex of calix[8]arenes exibiting strong magnetic anisotropy” Dalton Trans., pp. 4582-4588 (2007)—incorporated herein by reference].

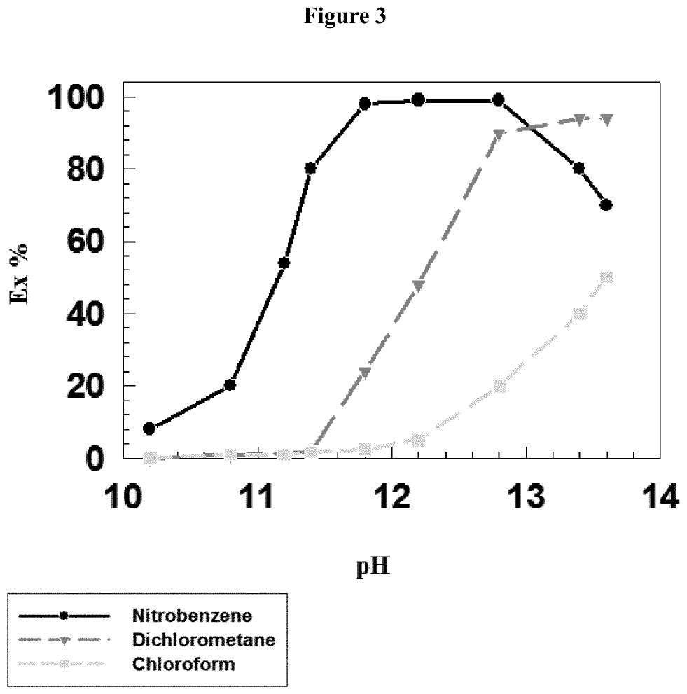

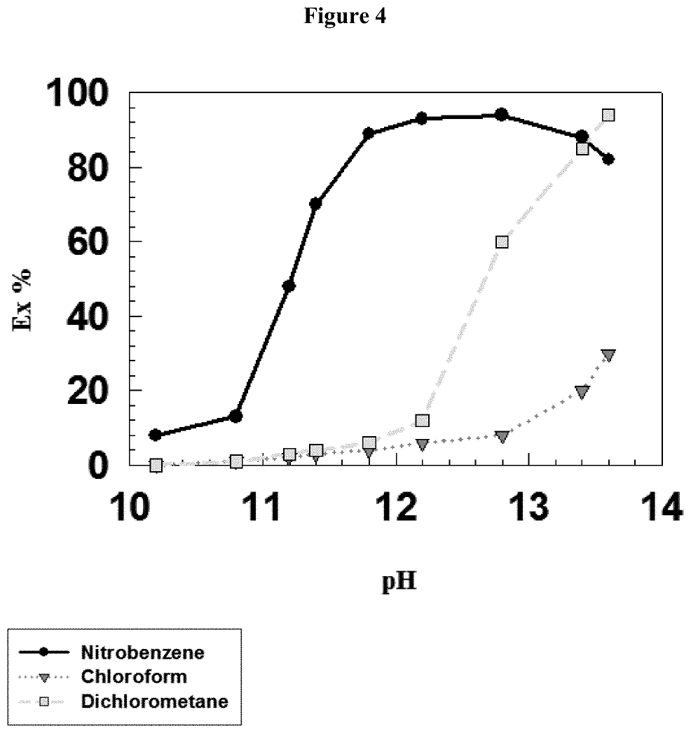

The extraction with nitrobenzene, dichloromethane, and chloroform were examined for both Cd²⁺ (FIG. 3) and Ni²⁺ (FIG. 4) in the pH range of 10-13.5. Nitrobenzene was very effective as an extractant for both Cd²⁺ and Ni²⁺ metal ions, extracting 96% of the metal ions in the pH range of 11.50-12.70. Dichloromethane was effective in the pH range 11.4-13 for Cd²⁺, whereas the effective pH range for Ni²⁺ was 12-13. Chloroform was less effective as an extractant at all pH values tested, showing only 50% extraction of Cd²⁺ and Ni²⁺ combined, and similar extraction percentages for Cd²⁺ and Ni²⁺ individually. It has been reported that H6L-metal ion complexes are obtained as adducts in chloroform (1 M); and chloroform could not be removed from adducts after heating at 130° C. for 3 days under reduced pressure. Such a result indicates that the chloroform molecule may be encapsulated within the cavity of the calixarene, in particular, for p-t-butylcalix[6]arene [H6L]. That may account for the low extraction percentage obtained with chloroform extraction [Yoshida et al. “Solvent extraction of copper (II) ion with p-t-butylcalix [6]arene from the ammonia alkaline solutions” Chem. Lett. pp 1535-1538 (1989)].

Among the three different organic solvents tested, nitrobenzene is found to be the most effective, and dichloromethane and chloroform are less effective. The exact cause of this behavior is not known. Masuda et al. [“The host-guest extraction chemistry of lighter lanthaniod (III) metal ions with p-t-butylcalix[6]arene from the ammonia alkaline solution in presence of succinic acid” Anal. Sci., Vol. 17, pp. a483-a486 (2001)] observed that the relative descending order of extraction with other solvents is not the same with H6L and that the order does not necessarily correlates with the order of their dielectric constants. Actually the extraction percentage of Ce(III) with H6L were 95%, 27% and 18% at pH 11.85 in nitrobenzene, dichloromethane, and chloroform. The dielectric constant of nitrobenzene, dichloromethane and chloroform are 34.82, 7.77 and 4.80, respectively. Therefore, the dielectric constant of the medium may have some contribution in the extraction process. However, the main factor determining the extraction efficiency in the extraction process must be taken into account and a better term correlating the relative extraction order is solubility parameter. Moreover, Thuéry et al. [“The first metal complex of an acyclic hexaphenol: structure of the binuclear complex of uranyl ions with an analogue of p-tert-butylcalix[6]arene” J. Chem. Soc. Dalton Trans., pp. 1481-1482 (1997)] reported that the reaction at room temperature between H8L and an excess of trimethylamine in chloroform, provided a solid that could be recrystallized in methanol to yield dark red crystals of new compound suitable for X-ray crystallography. Therefore, it is concluded that chloroform have affinity and/or suitable for complex formation with H8L ligand.

### Example 4

Distribution Analysis:

The partitioning of the metal ions in the presence of ammonia between two phases may be represented by equation (1):

M(NH₃)i²⁺+xH8L(o)+yNH₃ [symbol] M(NH₃)ᵢ⁺²(NH₂)_{y}H8Lₓ₍ₒ₎+YH⁺ (1)

Kₑₓ=[M(NH₃)ᵢ⁺²(NH₂)_{y}H8Lₓ]_{(O)}[H⁺]²⁺/[M(NH₃)i²⁺][H8L]^{x}_{(O)}[NH₃]^{y} (2)

where (O) indicates the species in the organic phase. Equation (2) can be simplified as follows using the distribution ratio of the metal (D=[M(NH₃)ᵢ⁺²H8L](O)/[M(NH₃)ᵢ²⁺]):

where (o) indicates the species in the organic phase. Equation (2) can be simplified by distribution ratio of the metal (D=[M(NH₃)ᵢ₊₂⁺²H8L](O)/[M(NH₃)ᵢ²⁺]):

K_{ex′}=D[H⁺]²⁺/[H8L]^{x}_{(O)}[NH₃]^{y} (3)

log D=log K_{ex′}+x log[H8L]_{(O)}+ypH+y log[NH₃] (4)

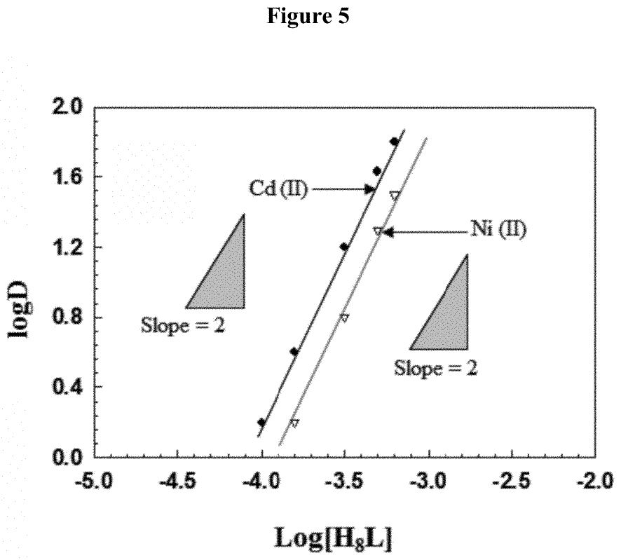

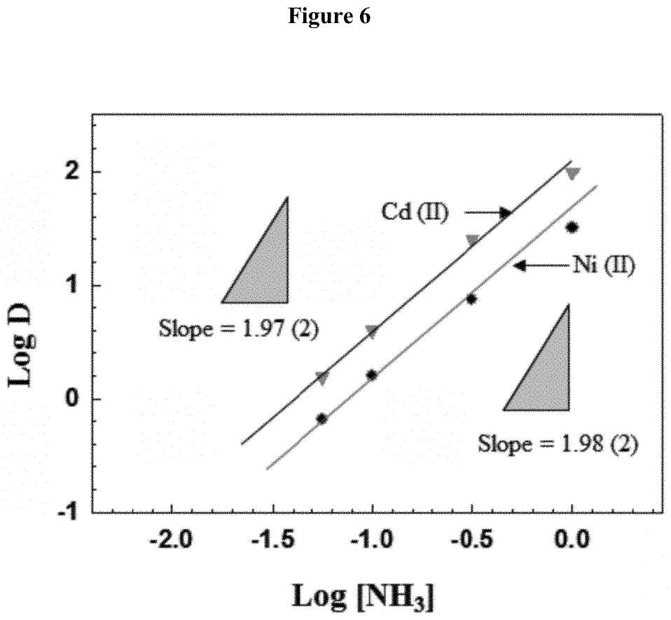

Since the extraction reagents exhibited high selectivity for Cd²⁺ and Ni²⁺, the stoichiometry of extraction of Cd²⁺ and Ni²⁺ determined. Distribution experiments were carried out in order to obtain information on the viability of the extraction process, the stoichiometry and distribution equilibrium of the extracted metal ions between the organic and aqueous phases, and the extent of Cd²⁺ and Ni²⁺ extraction. In the experiments, the concentrations of Cd²⁺ and Ni²⁺ were maintained constant at 1 mM, while the concentration of H8L was varied from 0.1 mM to 2 mM. Thus, the molar ratio of H8L to metal ion varied from 0.1 to 3.4. FIG. 5 shows plots according to equation 4 of Log D vs. Log [H8L] at constant concentrations of metal ions and ammonia, and pH are linear with a slope of 2. Similarly, plots of Log D vs. [NH3] at constant concentrations of metal ion concentration and H8L, and pH are linear with a slope of 2 (see FIG. 6). Thus, the extracted metal complex in organic solvent contains 2 moles of H8L for each mole of metal ion.

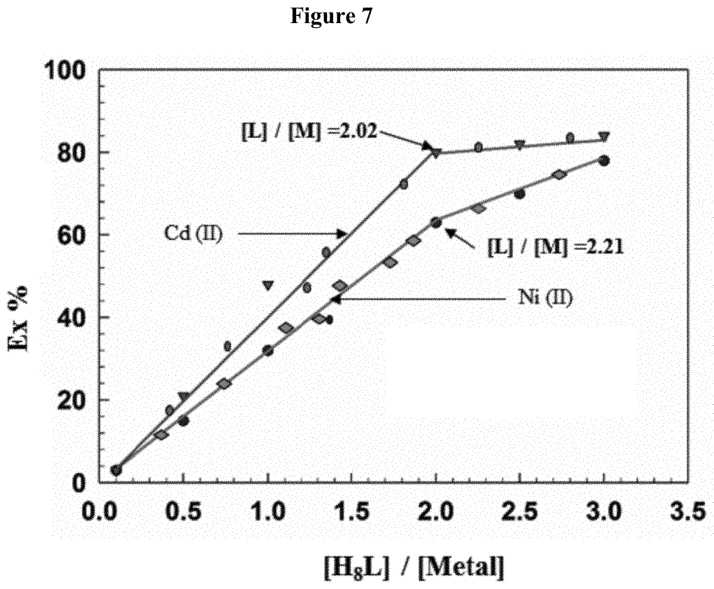

A plot of the residual concentration of Cd²⁺ and Ni²⁺ in the aqueous phase, against the relative concentration of H8L is presented in FIG. 7. Initially, experiments were completed three times to examine their reproducibility, and the results are also shown in FIG. 7. As can be seen, the extraction method showed good reproducibility. An extraction percentage of higher than 75% was obtained using H8L at low concentrations of Cd²⁺ and Ni²⁺. The Cd²⁺ and Ni²⁺ extracted under the same conditions, the higher Ex % of Cd²⁺ must be due to a higher extraction equilibrium constant compare to that of Ni⁺². That is why the slope of straight line after the inflection point in FIG. 7 becomes more horizontal in the upper line (Cd²⁺) than that of the lower line (Ni²⁺).

The extraction of transition metal ions with H8L from the aqueous phase, containing 0.1 M ethylenediamine [C₂H₄(NH₂)₂] or trimethylenediamine [(CH₂)₃(NH₂)₂] instead of ammonia, into dichloromethane solution was also examined. It is worth noting that extraction of Co²⁺ and Ni²⁺ from the aqueous phase containing ethylene diamine was suppressed (Ex %=0). On the other hand, Cu²⁺ and Cd²⁺ were extracted remarkably well (Cu²⁺=100% and Cd²⁺=90%) from the aqueous phase containing ethylene diamine. The interaction of calixarenes and amines in dichloromethane solution likely involves two-steps: (i) proton transfer from the calixarene to the amine to form a protonated amine, and (ii) the calixarene anion forms an endo-calix complex by association with the protonated amine [Akceylan et al. “Removal efficiency of a calix[4]arene-based polymer for water-soluble carcinogenic direct azo dyes and aromatic amines” J. Hazard. Mater., Vol. 162, pp. 960-966 (2009) incorporated herein by reference]. It is possible that the two steps take place simultaneously.

To understand complexation in the aqueous phase, the distribution ratio of ethylene diamine (en)₂-M and trimethylene diamine (en)₃-M species in the aqueous phase with each metal ion before extraction, using the formation constant with ethylene di and triamine was calculated. Table 1 shows the percentage of the metal ion-amine complex (M(en)₂ and M(en)₃ species) in the aqueous phase before extraction, and the percentage of metal ions extracted with H8L into dichloromethane. The distribution ratios for the complexations with H8L are comparable and indicative of high efficiency (Table 1). The value of the distribution ratios of M(en)₂ and M(en)₃ species in the aqueous phase before extraction are integers. As mentioned above, the extraction of Co²⁺ and Ni²⁺ metal ions was suppressed. Thus, most of the existing species in the aqueous phase are M(en)₃, while few M(en)₂ species were present. In contrast in the case of Cu²⁺, most of the species present in the aqueous phase were M(en)₂ species. The M(en)₂ species may divert and/or control the extraction with H8L from the aqueous phase containing ethylenediamine to some extent. It appears that small molecules are encapsulated by larger molecular and steric barriers hinder the guest from escaping from the host. From the above results, masking effect of metal ions with amines were also observed, particularly metal ions showing high affinity to amines.

TABLE 1
Extraction of transition metal ions with H8L from ethylenediamine
solution into dichloromethane at 25° C. and percentages of M(en)₂
and M(en)₃ in the aqueous phase before extraction

| Metal ion | ¹% E | | M(en)₂* (%) | M(en)₃** (%) |
|---|---|---|---|---|
| Co(II) | 0 | | 0 | 100 |
| Ni(II) | 0 | | 0 | 100 |
| Cu(II) | 97.0 | (2) | 100 | 40 |
| Zn(II) | 46 | (3) | 3 | 97 |
| Ag(I) | 52.7 | (5) | 99 | 35 |
| Cd(II) | 90.1 | (1) | 15 | 85 |

¹standard errors of the mean (N = 3) are in parenthesis determined
*(en)₂ is ethylenediamine and
**M(en)₂ M(en)₃ is ethylenetriamine.

The molar composition of the Cu²⁺ and Cd²⁺ extracted species were further examined. A plot of log D vs. log [H8L] is linear with a slope of 1, indicating a molar ratio of H8L:metal ion=1:1, which is different from the composition of species extracted from aqueous ammonia phase. Also, a plot of log D vs. pH for the extraction of Cu²⁺ is linear with a slope of 2.

Thus, the extraction equilibrium can be expressed as (en=H₂N(CH₂)₂NH₂):

M(en)₂²⁺+H8L_{(O)}=M(en)₂²⁺H8L_{(O)}+2H⁺ (5)

Table 2 shows the elemental analysis data of the Cu²⁺-H8L and Cd²⁺-H8L complexes. These data indicate that the extracted species from the aqueous phase containing ethylene diamine was M(en)₂ not M(en)₃, in agreement with our initial assumption based on Table 1.

TABLE 2
Elemental analysis of Cu²⁺-H8L and Cd²⁺-complexes

| Estimate based on | | | | Estimate based on | | | |
|---|---|---|---|---|---|---|---|
| chemical the formula Cu | | | | chemical the formula Cd | | | |
| (en)₂H8L.5H₂O) | | | | (en)₂H8L.3H₂O) | | | |
| | H | C | N | | H | C | N |
| | (%) | (%) | (%) | | (%) | (%) | (%) |
| Observed | 8.37 | 70.89 | 3.56 | Observed | 8.18 | 69.90 | 3.49 |
| Calculated | 8.73 | 70.40 | 3.57 | Calculated | 8.41 | 69.83 | 3.54 |

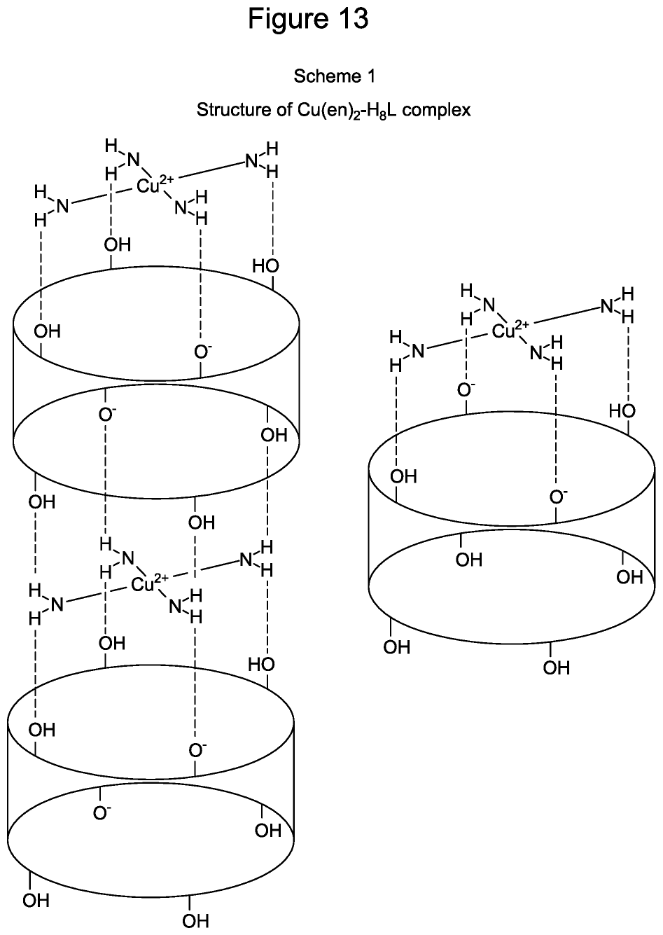

It has been reported that, in the extraction of metal ions using calix[n]arenes, the metal ion selectivity is related to the ring size of the calix[n]arene and to the radii of the metal ions [Gutsche et al. “Calixarenes. 4. The synthesis, characterization, and properties of the calixarenes from p-tert-butylphenol” J. Am. Chem. Soc., Vol. 103, pp. 3782-3792 (1981); and Gutsche et al. “Calixarenes. 22. Synthesis, properties, and metal complexation of aminocalixarenes” J. Am. Chem. Soc., Vol. 110, (18), pp. 6162-6272 (1988)]. The present extraction study using H8L accompanied by amines indicated that size is a key to selectivity, as the diameter of the H8L ring (4.0-4.4 Å) is sufficient to fit the M(en)₂ complex. The distance between the amino protons at both ends is ca. 4.0 Å. Based on the result presented herein, a plausible structure of Cu²⁺-H8L is shown in Scheme 1 of FIG. 13.

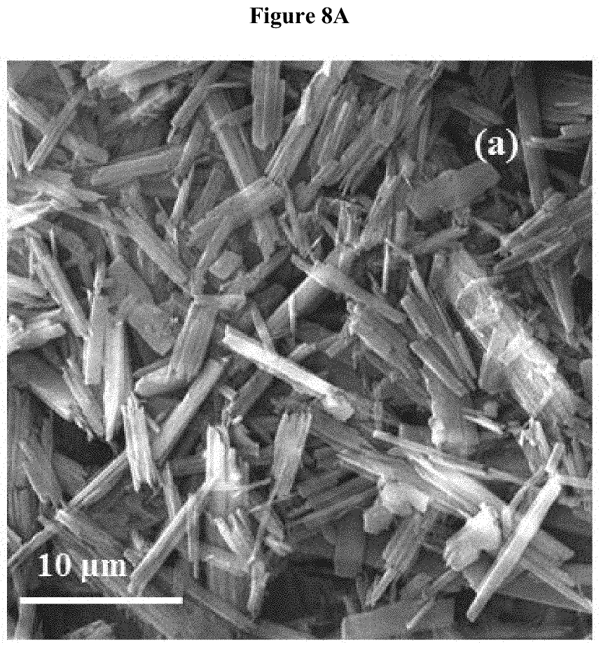

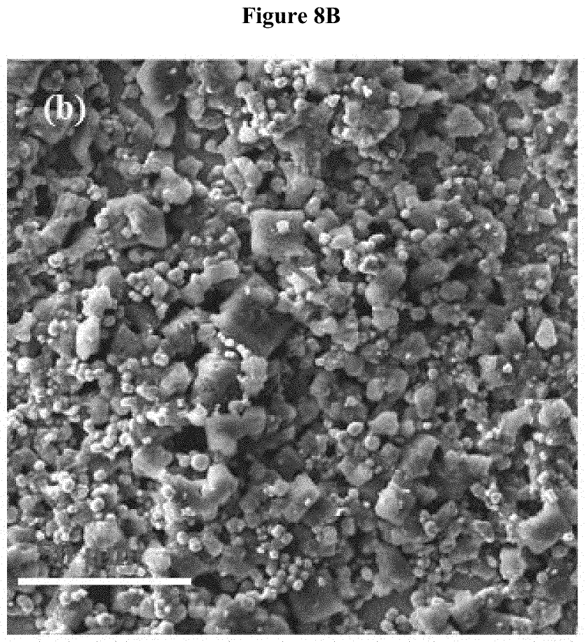

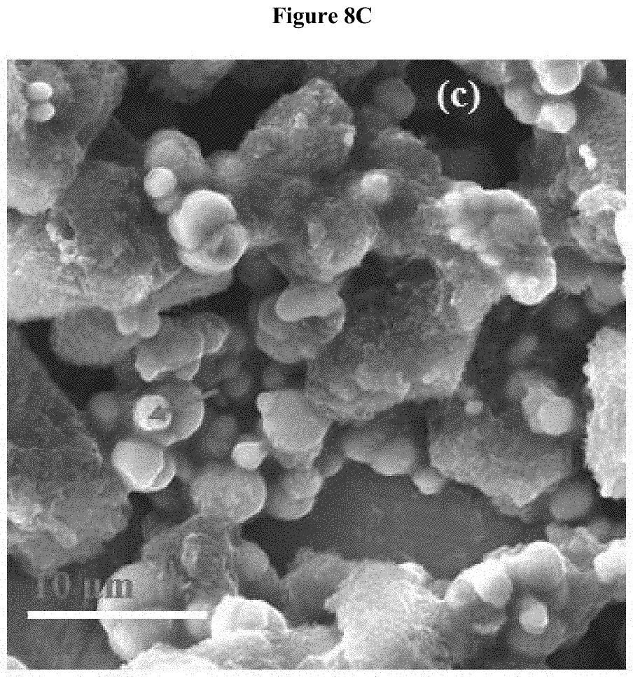

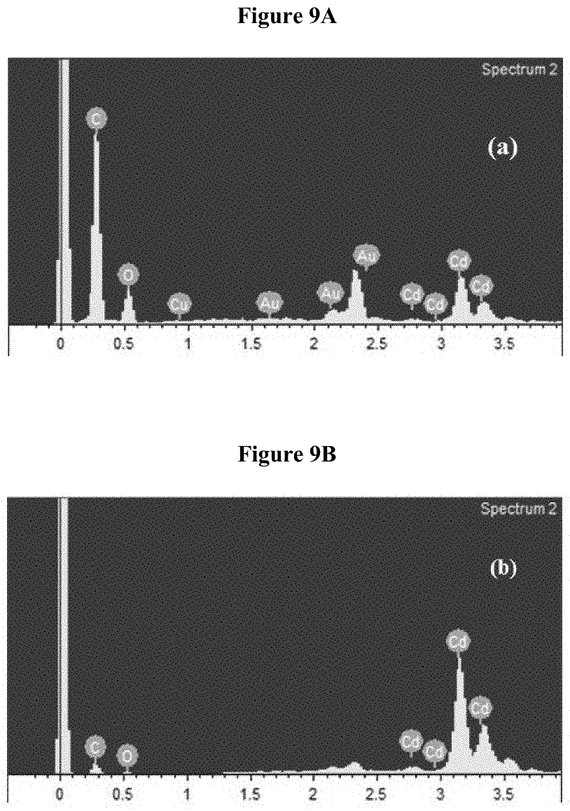

Therefore, the morphology and chemical structure of isolated Cd²⁺-H8L complexes were examined by FESEM, FTIR and ¹H NMR spectroscopy. FESEM images of H8L and Cd²⁺-H8L display different surface morphology. In the FESEM image, H8L had rod-like particles about 10 m long and less than 1 μm wide (FIG. 8A), whereas two types of particle sizes were observed in the FESEM image of the Cd²⁺-H8L complex (see FIGS. 8B and 8C). Nano-size spherical particles were Cd²⁺ ions and the square or bigger size particles were H8L as evidence by EDX analysis. The results of EDX and elemental analyses were consistent with each other. It is interesting that the Cd²⁺ ions were homogeneously dispersed and/or distributed over the H8L ligand. FIG. 9A shows the EDX spectrum of big particles marked by an arrow in FIG. 8B. The atomic percentage of C was 69.26 for the big size particles. Also, very little amount of Cd²⁺ was observed by EDX analysis of the larger particles. On the other hand, the spherical particles had mostly Cd²⁺ ion and atomic percentage of Cd was 33.78 (FIG. 9B, the EDX spectrum of spherical particle was based on FIG. 8C, marked by an arrow). Similar results were obtained for different location based on particles size. The EDX results shown in FIGS. 9A and 9B indicate the presence of Cd, C, Au, Cu and O. The Au and Cu were found due to gold coating over the sample and Cu substrate was used.

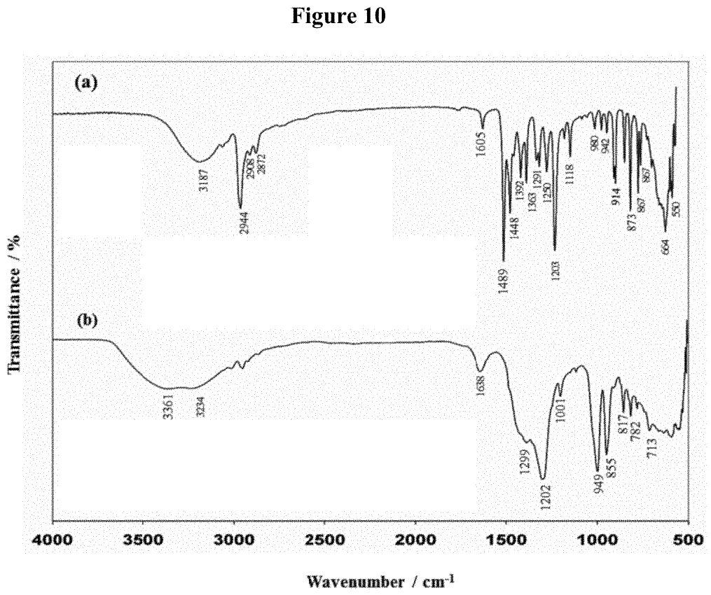

The FTIR spectrum of H8L and Cd²⁺-H8L is shown in FIG. 10 (top spectra (a) and bottom spectra (b), respectively). In the FTIR spectra of the complexes, the intensities or wave numbers of the stretching vibration of the OH groups change substantially with complexation due to the disruption of the strong intramolecular hydrogen bonding in the free ligands [Zahir, Md. H. (2013)]. The IR absorption bands at 3187 cm⁻¹ due to υN-H: free ethylene diamine [Pouchert, C. J. Aldrich Chemical Company, Inc. The Aldrich library of IR spectra, 3rd Ed.] shifted to 3361 cm⁻¹ upon extraction of Cd²⁺ with H8L indicating that hydrogen bonding was likely present in the M(en)₂-H8L complex. The associated nature of C(CH₃)₃, —CH₂— and hydroxyl group have been reported previously [Zahir, Md. H. (2013)]. The —C(CH₃)₃ gives a sharp absorption band at ca. 2944 cm⁻¹, which decreased substantially in intensity upon complex formation with Cd²⁺. Also, the ν(C═C) vibration bands shift from 1605 to 1638 cm⁻¹ upon complex formation. In addition, the strong vibration band of —CH₂— at 1489 cm⁻¹ almost disappeared upon complex formation. The differences in the infrared spectra may be caused by hydrogen bonding. As a whole, all the peaks of Cd²⁺-H8L composites were shifted to higher energy direction, indicating the strong interaction between Cd²⁺ and H8L.

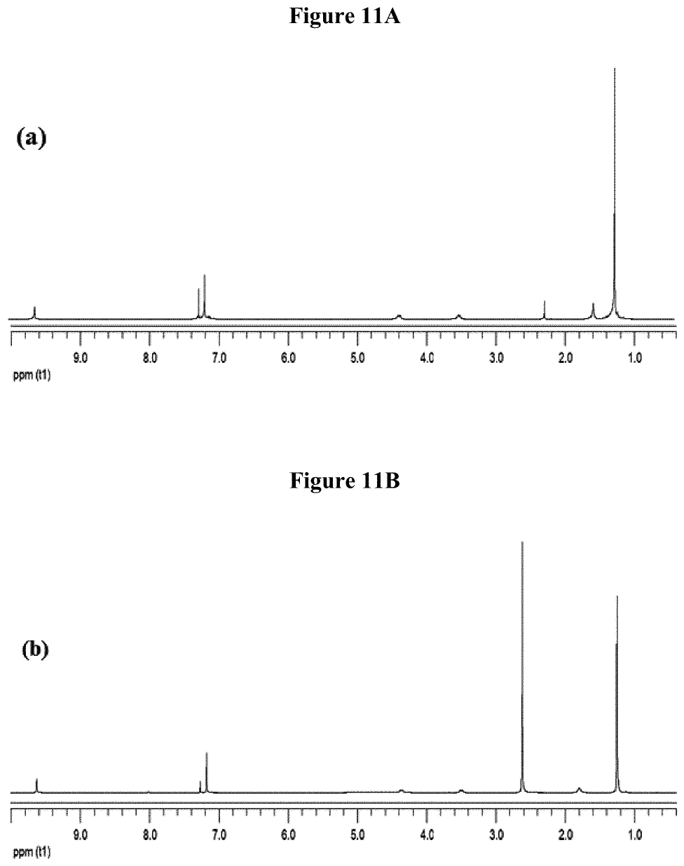

The solution behavior of the complexes was determined by ¹H-NMR spectroscopy in CDCl₃ at room temperature. In the spectra of H8L (FIG. 11A) and Cd²⁺-H8L (FIG. 11B), a singlet resonance for protons of —C(CH₃)₃ is observed at δ 1.25. For H8L, singlet resonances of aromatic protons are observed at δ 7.12 and 7.14 ppm, respectively; and a singlet for phenolic protons is observed at δ 9.63. In the spectra of the Cd²⁺-H8L complex, a new signal appeared at δ 2.62 ppm. Similar signal was previously observed at about δ 3.00 ppm for Ce³⁺-H8L and Ce³⁺-H6L, probably, for the bridging methylene groups due to the different environments of the hydrogen atoms [Zahir, Md. H. (2013)]. In the ¹H NMR spectra, peaks at 3.5 and 4.4 ppm were observed (due to the non-equivalent methylene protons (Ar-CHAHB-Ar) in the free H8L) which converge to 3.8 ppm in the Cd(en)₂-H8L complex after extraction. This indicates that the cone-shape conformation of H8L converts into the 1,3,5,7-alternate conformation.

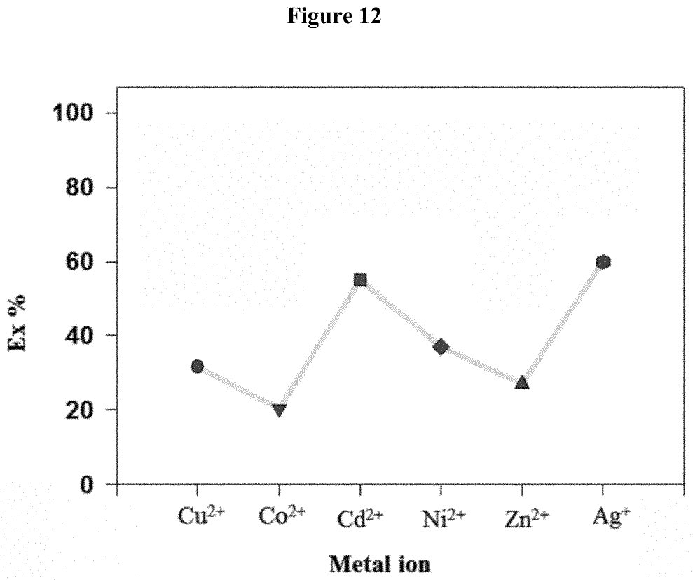

H8L-ester compounds were synthesized according to published procedures [Consoli et al. “Study on the Esterification of p-tert-butylcalix[8]arene,” J. Org. Chem., Vol. 61, pp. 2195-2198 (1996)]. The extraction percentage of any metal ion was poor throughout the entire range of pH used. In fact, the liquid-liquid extraction ability of transition metal ions with the H8L-ester-CH₂COOC₂H₅ derivative was low in comparison with H8L. It is thought that the H8L becomes an anion due to deprotonation. The H8L-ester, which is modified from calix[8]arene, is more flexible than both the calix[4]arene and calix[6]arene derivatives; however, it did not show a good extraction capability for Co^{2+,} Ni²⁺, Zn²⁺, and Ag⁺, as shown in FIG. 12.

1: A liquid-liquid extraction method for separating one or more metal ions from an aqueous composition comprising the metal ions, comprising:
dissolving a calix[n]arene compound in an organic solvent immiscible with water to form an organic solution, wherein n is an integer selected from the group consisting of 5, 7, 8, 9, and 10,
mixing the aqueous composition with at least one nitrogen base selected from the group consisting of ammonia, dimethyl amine and diethylamine at a nitrogen base concentration of 0.05 M to 1.5 M and succinic acid at a concentration of 2.0 mM to 50 mM, to form an aqueous composition having a pH of 11 to 13,
mixing the organic solution with the aqueous composition having a pH of 11 to 13 and comprising the metal ions to form a mixture,
agitating the mixture for a time sufficient for the calix[n]arene compound to form a complex with at least a portion of the metal ions and form an organic phase comprising the complex, and
allowing the mixture to separate into an organic layer and an aqueous layer, and
separating the aqueous layer from the organic layer, wherein the aqueous layer has a concentration of the metal ions that is less than the concentration of the metal ions in the aqueous composition prior to the mixing and agitating, and the complex is present in the organic layer.

2: The method of claim 1, wherein the calix[n]arene compound is substituted with an optionally substituted C1 to C10 linear or branched alkyl, an optionally substituted C3 to C8 cycloalkyl, an optionally substituted aryl, an optionally substituted heteroaryl substituted, OR₁, SR₁, SeR₁ and NR₁R₂, wherein R₁ and R₂ are independently hydrogen, an optionally substituted C1 to C10 linear or branched alkyl, an optionally substituted aryl, or an optionally substituted heteroaryl.

3: The method of claim 1, wherein the calix[n]arene compound is substituted with an optionally substituted methyl, an optionally substituted ethyl, an optionally substituted propyl, an optionally substituted n-butyl, an optionally substituted isobutyl, an optionally substituted t-butyl, an optionally substituted pentyl, an optionally substituted iso-pentyl, and an optionally substituted hexyl.

4: The method of claim 1, wherein the calix[n]arene compound is a calix[8]arene compound.

5: The method of claim 1, wherein the calix[n]arene compound is p-t-butylcalix[8]arene.

6: The method of claim 1, wherein the organic solvent is selected from the group consisting of nitrobenzene, chloroform, dichloromethane, dichloroethane and mixtures thereof.

7: The method of claim 1, wherein the concentration of the calix[n]arene compound in the organic solution is in the range of 10 μM to 1.0 mM.

8: The method of claim 1, wherein the aqueous composition comprises a nitrogen base at concentration in the range of 01 to 0.2 M.

9: The method of claim 8, wherein the nitrogen base is selected from the group consisting of ethylene diamine trimethylene diamine and mixtures thereof.

10: The method of claim 1, wherein the mixture further comprised a dicarboxylic acid other than succinic acid.

11: The method of claim 1, wherein the aqueous composition has a pH in the range of 11.5 to 12.5.

12: The method of claim 1, wherein the metal ion is a transition metal ion.

13: The method of claim 12, wherein the transition metal ion is at least one selected from the group consisting of Cd⁺², Ni⁺², Cu⁺², Ag⁺, Co⁺², and Zn⁺².

14: The method of claim 1, further comprising:
after the separating, extracting the calix[n]arene complex with an aqueous acid solution to regenerate the calix[n]arene compound, wherein the acid is selected from hydrochloric acid, nitric acid, sulfuric acid and mixtures thereof.
